(19) United States
(12) Patent Application Publication
(10) Pub. No.: US 2012/0104001 A1
(43) Pub. Date: May 3, 2012

(54) INSULATED CONTAINER

(76) Inventor: Oliver Kulzer, Rottenburg (DE)

(21) Appl. No.: 13/192,815

(22) Filed: Jul. 28, 2011

(30) Foreign Application Priority Data
Jul. 28, 2010 (DE) 10 2010 036 695.1

(51) Int. Cl. B65D 81/38; B23P 19/04

(52) U.S. Cl. 220/592.25; 29/428

(57) ABSTRACT

The invention concerns an insulated container whose outer walls are formed by a flexible outer skin, which forms a gap, with an insertion element, which is placed in the interior of the container and which is filled with an insulating and hardening foam body.

The invention under consideration concerns an insulated container to hold goods which are to be protected thermally.

Such a container, described in the preamble of claim 1, is known from the state of the art. The containers, which are used, in particular, in the food industry, mostly have a parallelepiped form. The side walls, including the container doors and bottom and lid, are thereby formed by rigid components, such as plates made of plastic or metal. In the production of the containers, a dimensionally stable vat, for example, made of glass-fiber reinforced plastic (GRP), is placed within the container walls, so that a gap forms between the container walls and the vat. This is foamed out with a hardening and insulating substance, so that the vat is thermally insulated with respect to the container surroundings and, at the same time, is kept stationary and stabilized.

The production process of such containers, however, is comparatively elaborate. Also, the components used have a high weight, wherein the container is, as a whole, heavier and more unwieldy. Also, the costs for the material and the process are high.

The goal of the invention under consideration is therefore to present an insulated container which can be produced more easily, quickly, and low-cost than the predecessors known from the state of the art. Also, the method for the production of the container should be correspondingly improved.

The goal is attained by an insulated container according to claim 1 and a method according to claim 9.

The invention is based on the finding that the surfaces adjoining the insulating foam bodies can be implemented, at least in part, by flexible means, which turn out to be very thin-walled and flexible and thus have a low weight. By forming the outer walls of the containers by means of such a flexible outer skin, the use of massive and dimensionally stable plate elements as side walls, known from the state of the art, becomes superfluous, and thus the foam body which is to be formed later is limited, in its spatial dimensions, toward the outside. Instead, either a few or all outer walls of the container are formed by the flexible outer skin (for example, in the form of a PVC film). A preferably parallelepiped carrier construction, shaping the container contours, is thereby used as a holder for the film, which can be drawn or wrapped around the carrier construction. An insertion element (for example, the previously mentioned vat made of GRP) is placed, in accordance with the invention, within the outer skin of the container, defined in this manner; the inside of the insertion element corresponds to the desired insulated volume.

In this way, a gap forms between the insertion element and the outer skin of the container; it is to be foamed out with the foam body so that, in a simple manner, an insulated container is formed, which, in contrast to the state of the art, is characterized by a low weight and its low cost. This is possible, in particular, in that the rigid outer container walls, known from the state of the art, are replaced by the considerably lighter, thinner, and more flexible outer skin of the container or film. In contrast to the state of the art, the interface to the foam body is formed, in accordance with the invention, by the flexible film. The rigid plate elements remaining up to now after the foaming out on the container are no longer needed in accordance with the invention.

The film can be placed not only “from the roll” on the most different carrier constructions—also, its weight per area is considerably below that of the known stable side plates. An eventually required stabilization of the flexible outer skin during the foaming, in the sense of the aforementioned casing, can be readily implemented with support plates, which, during the foaming, are temporarily adjacent, from the outside, on the flexible outer walls of the container formed by the film. In this way, a stable casing is produced on the outside of the carrier construction, which, after the hardening has been completed, can, once again, be completely removed. For the production of the next container, the same stabilization plates or even a casing body formed therefrom can again be temporarily used.

A substantial advantage of the invention is to be found in the fact that the outer skin formed from the film can be drawn or wound over the carrier construction, so as to simply and quickly constitute the outer contour of the container or its side surfaces. On the other hand, in the state of the art, the individual side wall elements are placed, from the inside, on the frame construction or affixed there, which signifies considerably more expense than the encompassing of the carrier construction with the flexible outer skin or film. The encompassing permits the formation of several side walls in one operation, for example, in that the film is wound laterally around or on the carrier construction with a width which, for example, corresponds to the height of the container, wherein in one rotation around the carrier construction, all (in particular, four) side surfaces of the container are formed, even if they are initially in an unstable or flexible form. By a suitable swiveling of the carrier construction and/or a roll releasing the film, it would even be possible also to cover, without transition, the lower and upper sides of the container with the film, which means a considerable acceleration, in comparison to the state of the art.

Another advantage is to be found in the fact that the film, in fact, completely covers each side surface of a container, in particular, without crannies and gaps. The side wall elements known from the state of the art, which are individually placed between the beams and rods of a carrier construction, always leave—of necessity and produced for construction reasons—crannies and gaps free, by means of which the foam exits to the outside during the foaming. The film, in accordance with the invention, or the process for its placement on the container avoids such leaks, because the film extends over the entire inside width of a container side, during the winding on the carrier construction, and surrounds or includes the rods and struts of the carrier construction on their surfaces and sides facing the outside. Therefore, the film continuously wrapped thereon forms no crannies and gaps, which, for the foaming in the state of the art, on the other hand, have to be sealed off separately and at a high cost.

An embodiment of the insulated container, in accordance with the invention, accordingly comprises a preferably parallelepiped carrier construction for the formation of some or all side edges of the container. Furthermore, an insertion element is provided, which is located between the outer walls of the container and forms an insulated volume with its inside. In accordance with the invention, the container has a flexible outer skin which is carried by the carrier construction and forms the outer walls of the container, wherein a gap, formed between the insertion element and the outer walls of the container, is foamed by a thermally insulating and hardening foam body. At least one outer wall of the container or a part thereof can be formed by a door. In this case, the insertion element, which, for example, can have the form of a vat, is placed in the container with its opening opposite the door.

As stated before, a dimensionally stable vat, whose interior space determines the insulated volume, is suitable as the insertion element. Such a vat can be stabilized, if necessary, by a suitable core, during foaming, so as to be able to withstand the pressure. As a dimensionally stable vat, it also offers sufficient strength against damage to the foam in the space behind during the later operation of the container.

However, a particularly advantageous alternative embodiment of the insulated container, in accordance with the invention, also provides the selection of a flexibly deformable structure like a shell, in particular, a PVC shell, for the insertion element. In contrast to a rigid insertion element, such a flexible shell offers similar advantages, such as the flexibly shaped outer skin of the container. It is low-cost, light, and almost arbitrarily deformable also, due to its flexible nature, so that the shape of the insulated interior can be prespecified easily and individually. Since the dimensionally stable, heavy vat, known from the state of the art, by means of which the shape of the interior is prespecified essentially rigid, can then be dispensed with, the costs of this vat and the end weight of the insulated container can also be reduced.

In order to suitably stabilize such a flexible insertion element, like a film, for the foaming process, a core is appropriately used, which essentially assumes the desired insulated volume and with at least one part of its surface, supports, as casing, the film which is to limit the insulated volume during the foaming. Such a core could, for example, protrude, for example, by a recess in the outer wall of the container, which is the later door opening, into the interior of the container, defined by the outer walls of the container. A film or shell, as a flexible insertion element, lying closely to the core, thereby defines the insulated volume, which is not to be foamed. A gap is formed, in accordance with the invention, between the core covered by the film and the outer walls of the container; it is to be selected sufficiently large in agreement with the characteristics of the foaming material. The gap has typically the shape of a vat, whose wall thickness corresponds to the later insulating layer between the insulated volume the outer wall of the container. For a better removal of the core after the foaming has taken place, it can have slightly conical side surfaces, which readily branch out in the direction of the container door (through which the core is removed).

The stabilization of the outer walls of the container, which are, typically, essentially planar, can take place in the manner already described by support plates, which lie on the outer skin, from the outside, and which prevent the bulging out of the outer skin or container wall during the foaming.

The container, in accordance with the invention, with a flexible outer skin and flexible insertion element advantageously dispenses with the incorporation of rigid and heavy plate elements or vats as partial side elements. Instead, the film, which is, in fact, flexible, forms the interface to the foam body during the foaming. The casings required for the foaming are formed by support means which are to be placed temporarily (stabilization plates on the outside of the container or core in the interior of the container), which make it possible to match accurately the subsequent foaming of the gap remaining between the casing elements.

Since the auxiliary means supporting the films can, once again, be removed after the hardening has taken place, the container subsequently consists essentially only of the foam body itself, the thin-walled film on the outside and inside, and the carrier construction. The carrier construction can thereby run only along the outside edges of the container, so as to protect the foam body, particularly on these zones, from damage. The affixing of the container door on the carrier construction is likewise conceivable.

Within the scope of this application, “insertion element” is understood to mean the material and the structure which limits the insulated volume toward the outside. An insertion element can be a rigid structure, such as a stable vat made of GRP. In particular, an insertion element, however, can also be a volume-shaped flexible film, which is, in fact, initially unstable. An insertion element can be unilaterally stabilized by a core for the purpose of foaming.

Depending on the natural characteristics of the foam body, it is possibly sensitive to local damage or deformation. In order to avoid such damage, an embodiment of the insulated container, in accordance with the invention, provides for the placement of reinforcement means on the side of the insertion element facing the foam body and/or the outer skin, so as to protect the foam body there from undesired deformation or damage. The reinforcement means can thereby be plastic plates or angle profiles, which are placed, before the foaming, on the endangered sites (for example, in the area of the outer edges of the container or also outside or to the side of the insulated volume in the gap), so as to bind them there firmly in the frame of the foaming or to integrate them into the foam body. Appropriately, they form an interface to the immediately adjacent film, so as to be able to provide direct resistance to a damaging force from beyond the film—that is, from the interior of the container or from outside the container.

Another substantial advantage of the insulated container, in accordance with the invention, consists in that a simple shaping of the insulated volume and/or the outer wall of the container is possible by the use of a flexible outer skin and, in particular, by the use of a flexible insertion element. In this way, it is possible to form, very simply, specific functional elements of the container, produced by profile shaping, such as insertion grooves, stops, indentations, or the like. These are to be taken into consideration only in the shaping of the insertion element or the outer skin of the container—for example, in that the casing elements (core in the interior or the outer stabilization elements) are formed with the complementary profile, so that the films cling to this form and the corresponding profilings harden during the foaming.

Appropriately, the insulated container, in accordance with the invention, with its carrier construction and/or the hardened foam body can be joined with a movable frame, in a detachable manner. Thus, the container can be placed, for example, on a roller plate and can move with it, which advantageously expands the usage possibilities of the container. The clear weight savings of the container as a result of the flexible outer skin or the flexible insertion element manifests itself thereby on the dimensioning of the movable frame also, wherein, in turn, there can be a savings in material and costs.

From the preceding description, the steps, in accordance with the invention, for the production of an insulated container can be deduced as follows:

a) Making available a preferably parallelepiped carrier construction for the formation of some or all side edges of the container;

b) placement of a flexible outer skin on the carrier construction for the formation of the outer surfaces of the container;

c) placement of an insertion element between the outer surfaces of the container, wherein the insertion element forms an insulated volume, with its interior.

d) stabilization of the flexible outer skin against deformation;

e) foaming of a gap, formed between the insertion element and the outer surfaces of the container, with a thermally insulating and hardening foam body.

An advantageous embodiment of the invention is explained below with the aid of a figure example. The figures show the following:

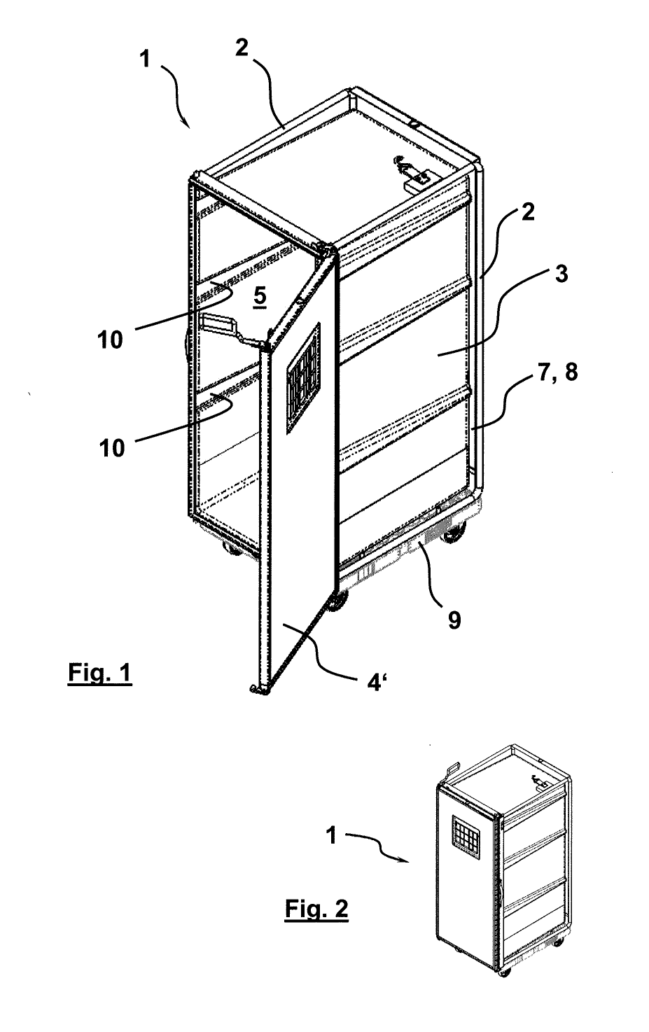

FIG. 1, a schematic view of the container, in accordance with the invention;

FIG. 2, the container, according to FIG. 1, with closed door;

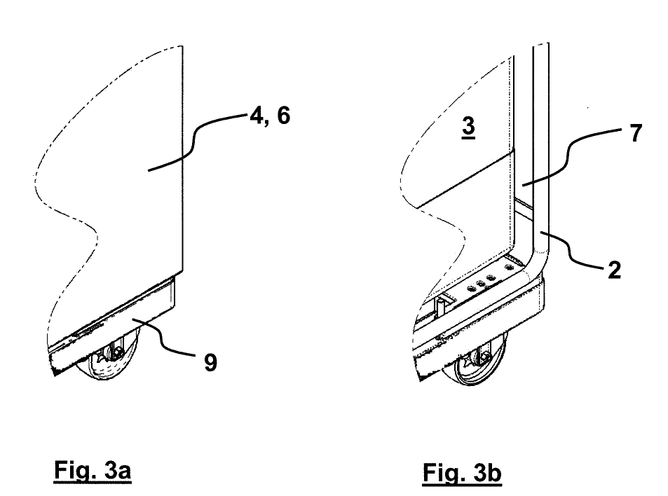

FIG. 3a, 3b, two detailed views of a container with/without side wall.

FIG. 1 shows an insulated container 1. This comprises a parallelepiped carrier construction in the form of a metal tubular frame 2. The tubular frame 2 essentially determines the outer dimensions of the container 1.

Within the tubular frame 2, an insertion element 3 is placed, which has the shape of a vat with a slightly conical side surfaces. The insertion element 3 is opened to toward a front side of the container 1 and, with its interior, defines an insulated volume 5.

The carrier construction 2 is covered with a flexible outer skin 6, wherein the outer surfaces 4 of the container are defined (see FIG. 3a, 3b). In this way, a space 7 is formed in the shape of a gap, which surrounds the insertion element on five sides, between the outer surfaces 4 of the container and the insertion element 3. By foaming this gap 7 with an insulating and hardening foam body 8, the insertion element 3 is, on the one hand, stabilized in its position and shape and, on the other hand, the interior of the insertion element is thermally insulated with respect to the surroundings of the container. The opening of the insertion element toward the door is closed by just this door 4′, which is suitable for insulation, as shown in FIG. 2.

During the foaming, a core, which is not depicted in FIG. 1, is appropriately placed in the interior of the insertion element 3, which, in size and shaping, corresponds to the desired insulated volume. The insertion element formed by a flexible film adapts to this core and assumes the shape complementary to the core during and after the hardening of the foam body.

In an analogous manner, before the foaming of the space 7, a stabilization of the outer walls 4 of the container, formed by a flexible film, also takes place, for example, by stabilization plates which are adjacent to the outer wall of the container, from the outside, which stabilize the outer films 6, during the foaming, in their preferably plane shape. By a suitable profiling of the stabilization plates and/or the core, the foam body 8 can, moreover, undergo a special functional shaping, such as insertion grooves 10, recessed grips, stops, discharge channels, or the like.

The front side of the container 1 or the insertion element 3 is closed by a door 4′. Preferably, the door 4′ likewise has a flexible skin on its inside and outside, wherein the gap lying inbetween is likewise formed by a hardening foam body. Alternatively, a traditional rigid container door is also conceivable, wherein the door is preferably affixed on the carrier construction 2 or can be locked with it.

The container 1, in accordance with the invention, rests on a roller plate 9, with which it can be flexibly moved. The container 1 can thereby by joined with the roller plate 9, in a detachable manner, so that, if needed, it can also be placed in a stationary manner.

FIG. 3 shows the rear, lower section of the container 1, in detail. In the depiction according to FIG. 3a, the outer surface 4 of the container is wrapped, in the shape of the film 6, over the carrier construction 2. Such a space 7, between the insertion element and the film 6, covered by the film 6, can already be filled with a hardened foam body, so that FIG. 3a shows the container in its hardened end state.

In FIG. 3b, on the other hand, the outer wall 4 and the film 6 are removed, so that the insertion element 3 can be seen in the interior of the carrier construction 2, before the foaming. The aforementioned space 7 is used as the gap to be foamed, wherein the interior of the insertion element 3 is thermally insulated from the surroundings of the container beyond the outer skin 4.

1. Insulated container (1) to hold goods to be insulated thermally, with
a) a preferably parallelepiped carrier construction (2) for the formation of some or all side edges of the container (1); and
b) with an insertion element (3), which is placed between the outer walls (4) of the container and which, at least in part, defines an insulated volume (5) with its interior;
characterized in that
c) the container (1) has a flexible, thin, film- or sheet-like skin (6), which forms outer surfaces (4) of a container; and
d) a space (7), formed between the insertion element (3) and the outer skin (6), is foamed by a thermally insulating and hardening foam body (8).

2. Insulated container according to claim 1, characterized in that an outer wall of the container is a door (4′), which closes the insertion element (3).

3. Insulated container according to the preceding claims, characterized in that the insertion element (3) is formed like a dimensionally stable vat.

4. Insulated container according to one of claim 1 or 2, characterized in that the insertion element (3) is a flexibly deformable structure like a shell, in particular, a PVC shell.

5. Insulated container according to the preceding claim, characterized in that the insertion element (3) can be dimensionally stabilized for the foaming of the space (7) by a core which defines the insulated volume (5) and which is laid in the insertion element (3).

6. Insulated container according to one of the two preceding claims, characterized in that reinforcement means are placed on the side of the insertion element (3), facing the foam body (8) and/or the outer skin (6), so as to protect the foam body (8) from an undesired deformation or damage.

7. Insulated container according to one of the preceding claims, characterized in that the outer skin (6) and/or the insertion element (3) has, in places, a defined shaping (10), so as to form, in this way, functional elements of the container (1).

8. Insulated container according to one of the preceding claims, characterized in that the carrier construction (2) and/or the foam body (8) can be connected or is connected with a movable frame (9), in a detachable manner.

9. Method for the production of an insulated container (1), comprising the following steps:
a) Making available a preferably parallelepiped carrier construction (2) for the formation of some or all side edges of the container (1);
b) placement of a flexible outer skin (6) on the carrier construction for the formation of the outer surfaces of the container (4);
c) placement of an insertion element (3) between the outer skins (6), wherein the insertion element (3) forms an insulated volume (5), with its interior;
d) stabilization of the flexible outer skin (6) against deformation;
e) foaming of a space (7), formed between the insertion element (3) and the outer skin (6), with a thermally insulating and hardening foam body (8).

10. Method according to the preceding claim, characterized in that :
a) a flexibly deformable structure like a shell, in particular, a PVC shell, is used as an insertion element (3);
b) wherein the insertion element (3) is stabilized against an unwanted deformation before the foaming, preferably by a core inserted into the insertion element.
